(19) United States
(12) Patent Application Publication
(10) Pub. No.: US 2006/0245613 A1
(43) Pub. Date: Nov. 2, 2006

(54) Sounding body unit for preventing occurrence of abnormal sounds

(75) Inventors: Toshiyuki Itoh, Kawasaki (JP); Nariyasu Hayakawa, Kawasaki (JP); Tetsuya Fujimoto, Kato (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/230,602

(22) Filed: Sep. 21, 2005

(30) Foreign Application Priority Data
Apr. 28, 2005 (JP) 2005-132693

(51) Int. Cl. H04R 1/02

(52) U.S. Cl. 381/388

(57) ABSTRACT

A sounding body unit has a sounding body, a mesh section, and a housing mounting the sounding body with the mesh section. The housing has a projection, and the projection is pressed against the mesh section in order to prevent the mesh section from resonating with sounds radiated from the sounding body.

### CROSS REFERENCE TO RELATED APPLICATION

This application is based upon and claims the benefit of priority from the prior Japanese Patent Application No. 2005-132693, filed on Apr. 28, 2005, the entire contents of which are incorporated herein by reference.

### BACKGROUND OF THE INVENTION

1. Field of the Invention

The present invention relates to a sounding body unit and, more particularly, to a sounding body unit serving as a structure by which the sounding body is mounted in a housing with a mesh section and prevented from resonating with sounds radiated from the sounding body.

Incidentally, the sounding body employed in the sounding body unit according to the present invention includes not only a loudspeaker that radiates sounds, which are generated by a compact communications terminal, a telephone set, portable music reproduction equipment, a compact radio, or the like, to the outside but also, for example, a buzzer that realizes an alarm facility.

2. Description of the Related Art

In recent years, for example, a compact communications terminal, a telephone set, portable music reproduction equipment, a compact radio, or the like has a loudspeaker, that radiates sounds to the outside, and a loudspeaker mesh that is interposed between the loudspeaker and a housing for the purpose of making the loudspeaker indiscernible and preventing invasion of dust and dirt and permeation of dripping water.

However, for example, when incoming call sounds are radiated from a loudspeaker, the loudspeaker mesh resonates with the sounds radiated from the loudspeaker. The resonance of the loudspeaker mesh causes interference between the loudspeaker mesh and the housing or the loudspeaker and eventually causes noise. Consequently, the clarity of the sounds from the loudspeaker is impaired to degrade the quality of the sounds.

For example, Japanese Unexamined Patent

Publication (Kokai) No. 11-004493 has disclosed a dustproof net in efforts to overcome a drawback that a loudspeaker included in a loudspeaker mounting structure having a sheet of dustproof net comes into contact with the dustproof net to cause abnormal noises, or a drawback that the dustproof effect is degraded due to a displacement of the dustproof net. In the dustproof net, an annular spacer made of a PET or the like and having elasticity is bonded to the machined end of a lightweight mesh sheet made from nylon fibers in order to create a space between the dustproof net and a cone made of paper and included in the loudspeaker. Moreover, owing to the elasticity and annular shape, the spacer helps the dustproof net retain its planar shape and prevents the dustproof net from being bent or deformed.

The prior art and its associated problem will be described in detail later with reference to relevant drawings.

### SUMMARY OF THE INVENTION

An object of the present invention is to provide a sounding body unit that can nullify the resonance of a mesh section with sounds radiated from a sounding body, and that can prevent occurrence of abnormal sounds due to the resonance of the mesh section or interference with a housing or the like derived from the resonance.

According to the present invention, there is provided a sounding body unit comprising a sounding body, a mesh section, and a housing mounting the sounding body with the mesh section, wherein the housing has a projection; and the projection is pressed against the mesh section in order to prevent the mesh section from resonating with sounds radiated from the sounding body.

According to the present invention, there is also provided a device having a sounding body unit, the sounding body unit comprising a sounding body, a mesh section, and a housing mounting the sounding body with the mesh section, wherein the housing has a projection; and the projection is pressed against the mesh section in order to prevent the mesh section from resonating with sounds radiated from the sounding body.

The sounding body may be a loudspeaker that radiates sounds or voice to the outside from the housing; and the mesh section may be a net interposed between sound release cavities formed in the housing and the loudspeaker, preventing invasion of dust and dirt, preventing permeation of dripping water, and improving an appearance of the housing.

The projection may be formed around the sound release cavities formed in the housing, and have a linear planar shape, a curved planar shape, or a combination of the shapes. The projection may have a rectangular section or a rectangular section whose end that comes into contact with the mesh section is rounded. The projection may be formed on a crosspiece between the sound release cavities formed in the housing.

The projection may be formed as an integral part of the housing. The projection may be formed on a center crosspiece between the sound release cavities formed in the housing, and realized with a substantially conical projection having a circle-like planar shape and a triangular section.

### BRIEF DESCRIPTION OF THE DRAWINGS

The present invention will be more clearly understood from the description of the preferred embodiments as set forth below with reference to the accompanying drawings, wherein:

FIG. 1A and FIG. 1B shows a fold-down mobile cellular phone as an example to which a sounding body unit in accordance with the present invention is adapted;

FIG. 2 shows an example of a loudspeaker mounting structure in accordance with a prior art (part 1);

FIG. 3 shows an example of a loudspeaker mounting structure in accordance with a prior art (part 2);

FIG. 4 shows an example of a loudspeaker mounting structure in accordance with a prior art (part 3);

FIG. 5 shows an example of a loudspeaker mounting structure in accordance with a prior art (part 4);

FIG. 6 shows an example of a loudspeaker mounting structure in accordance with a prior art (part 5);

FIG. 7 shows an example of a loudspeaker mounting structure in accordance with a prior art (part 6);

FIG. 8 shows an embodiment of the sounding body unit (loudspeaker mounting structure) in accordance with the present invention;

FIG. 9 shows the back of a mobile cellular phone that is an example to which the sounding body unit in accordance with the present invention is adapted;

FIG. 10A, FIG. 10B, FIG. 10C, and FIG. 10D show examples of a projection included in the sounding body unit in accordance with the present invention; and

FIG. 11A and FIG. 11B show examples of waveforms measured using the loudspeaker mounting structures in accordance with the prior art and the present invention respectively.

### DESCRIPTION OF THE PREFERRED EMBODIMENTS

Before proceeding to the detailed description of an embodiment of the present invention, sounding body units in accordance with prior arts and their underlying problems will be described with reference to the drawings below.

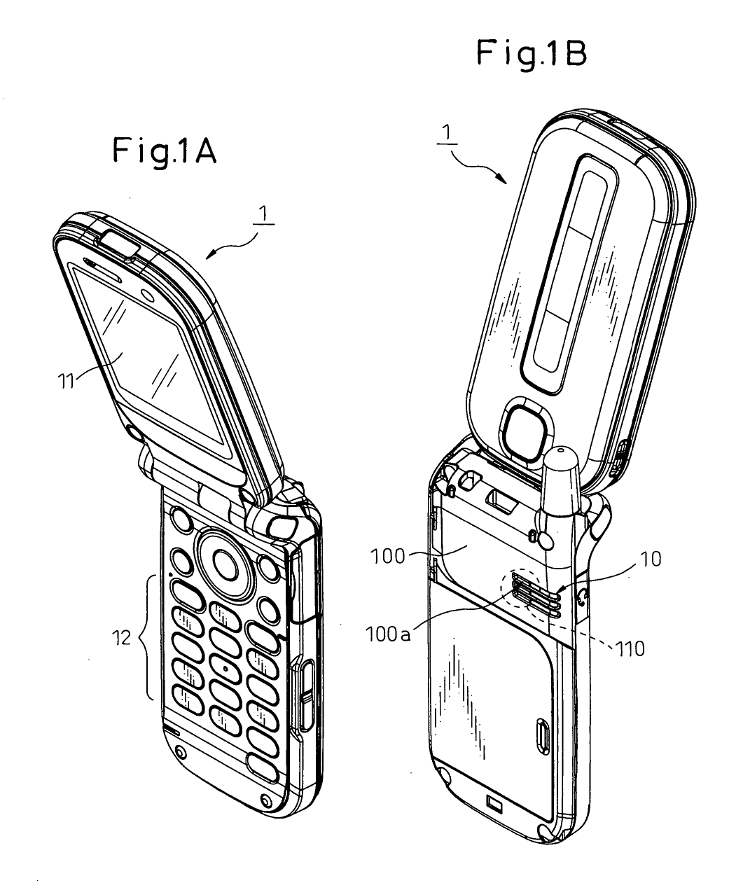

FIGS. 1A and 1B show a fold-down mobile cellular phone 1 that is an example to which a sounding body unit in accordance with the present invention is adapted. FIG. 1A is a perspective front view of the mobile cellular phone 1 that is left open (showing an operating side that includes a display 11 and input keys 12). FIG. 1B is a perspective back view showing the mobile cellular phone 1 that is left open.

Referring to FIGS. 1A and 1B, there is shown a loudspeaker unit 10 in which incoming call sounds or voice radiated from a loudspeaker (sounding body) 110 is released to outside the mobile cellular phone 1 through sound release cavities 100a formed in a housing 100. A sounding body unit in accordance with the present invention is not limited to the loudspeaker unit that radiates the incoming call sounds or voice and that is incorporated in a mobile cellular phone. The sounding body unit in accordance with the present invention can be widely adopted as sounding body units to be incorporated in various pieces of equipment together with a mesh. For example, the sounding body unit in accordance with the present invention can be adopted as loudspeaker units to be incorporated in portable music reproduction equipment and a compact radio together with a mesh.

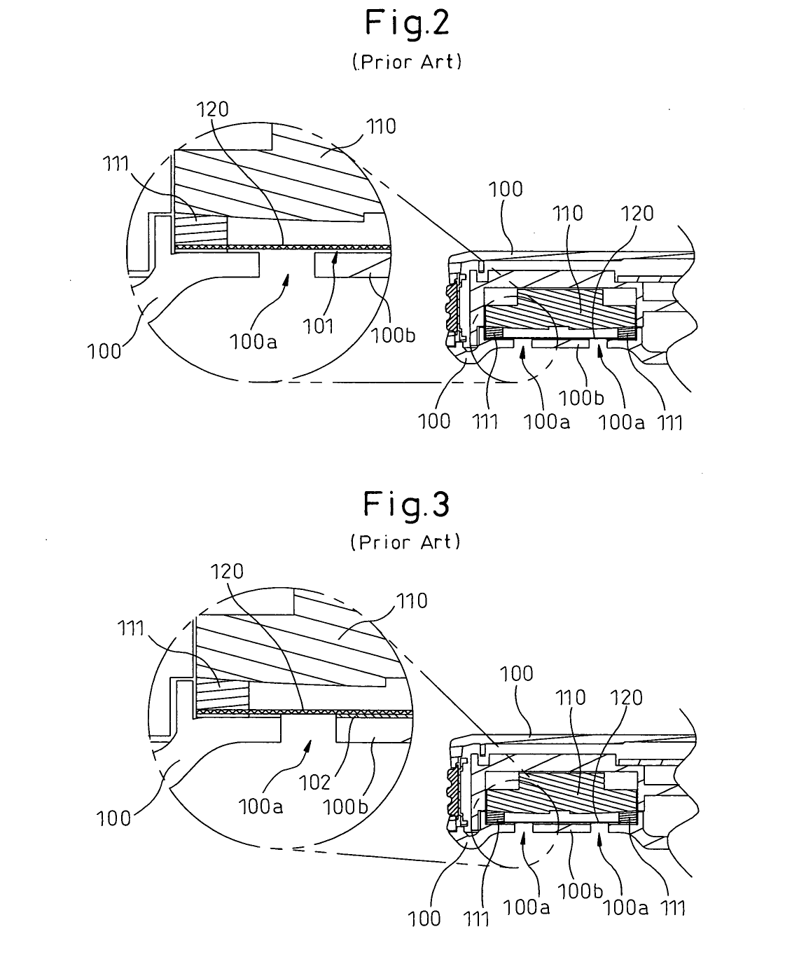

FIGS. 2 to 7 show examples of loudspeaker mounting structures in accordance with prior arts.

As shown in FIG. 2, a loudspeaker mounting structure (loudspeaker unit) in accordance with a prior art has, for example, a loudspeaker 110 mounted in a housing 100 via a loudspeaker cushion 111 and a loudspeaker mesh 120. The loudspeaker mesh 120 makes the loudspeaker 110 indiscernible when a mobile cellular phone 1 is seen from outside. Moreover, the loudspeaker mesh 120 is used to prevent invasion of dust and dirt or permeation of dripping water or to protect the loudspeaker 110 from dust and dirt or rainwater. Moreover, incoming call sounds or voice radiated from the loudspeaker 110 is effectively released to the outside through the sound release cavities 100a formed in the housing 110.

In the loudspeaker mounting structure according to the prior art shown in FIG. 2, for example, a minute space 101 is created between a crosspiece 100b extending between the sound release cavities 100a formed in the housing 100 and the loudspeaker mesh 120. For example, when the loudspeaker 110 radiates incoming call sounds, the loudspeaker mesh 120 interposed between the loudspeaker 110 and the housing 100 resonates with the sounds radiated from the loudspeaker 110. The resonance of the loudspeaker mesh 120 or interference with the housing 100 or loudspeaker 110 derived from the resonance causes a noise. The noise impairs the clarity in the sounds radiated from the loudspeaker 110 and eventually degrades the quality of the sounds.

FIGS. 3 to 7 show various examples of loudspeaker mounting structures having been proposed in the past. The loudspeaker mounting structures have been proposed in efforts to improve the loudspeaker mounting structure shown in FIG. 2.

The loudspeaker mounting structure shown in FIG. 3 has the minute space 101, which lies between the crosspiece 100b extending between the sound release cavities 100a formed in the housing 100 and the loudspeaker mesh 120 included in the loudspeaker mounting structure shown in FIG. 2, filled with an adhesive 102, and thus attempts to minimize the resonance of the loudspeaker mesh 120.

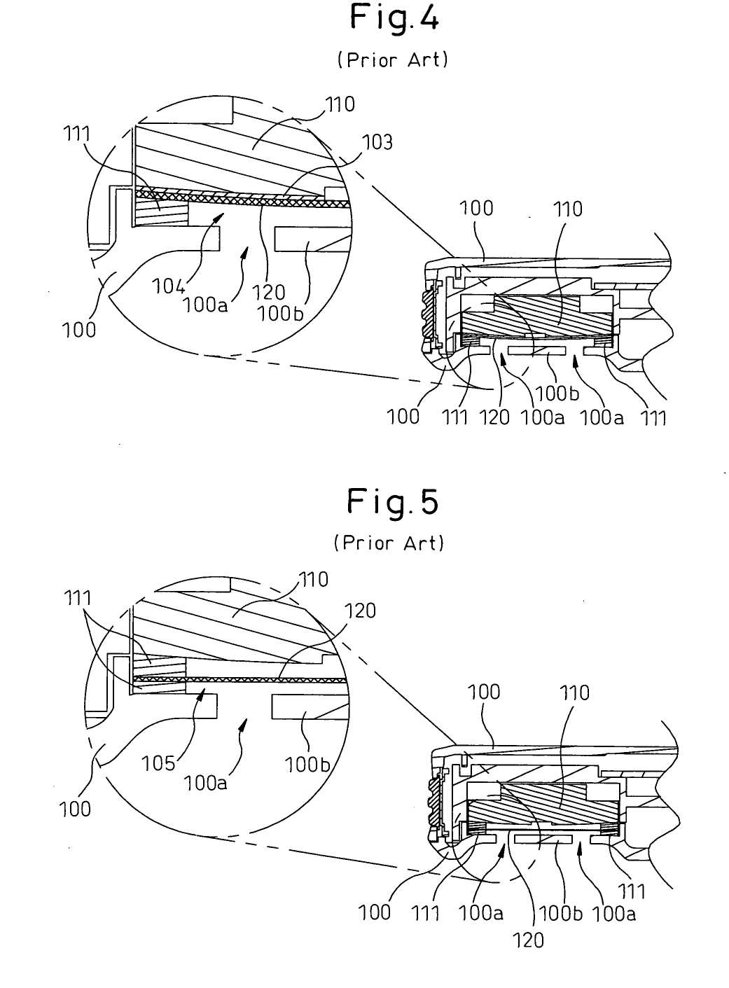

Moreover, the loudspeaker mounting structure shown in FIG. 4 has the loudspeaker mesh 120 bonded to the loudspeaker 120 (a cover of the loudspeaker unit) using an adhesive 103, and thus attempts to minimize the resonance of the loudspeaker mesh 120. In this case, a large space 104 is created between the housing 100 in which the sound release cavities 100a are formed and the loudspeaker mesh 120.

In the loudspeaker mounting structure shown in FIG. 2, the minute space 101 lies between the crosspiece 100b that extends between the sound release cavities 100a formed in the housing 100, and the loudspeaker mesh 120. In contrast, the loudspeaker mounting structure shown in FIG. 5 has a wide space 105 created between the crosspiece 100b and the loudspeaker mesh 120. Owing to the devised loudspeaker cushion 111, even if the loudspeaker mesh 120 resonates, no abnormal noises occur due to interference with the housing 100.

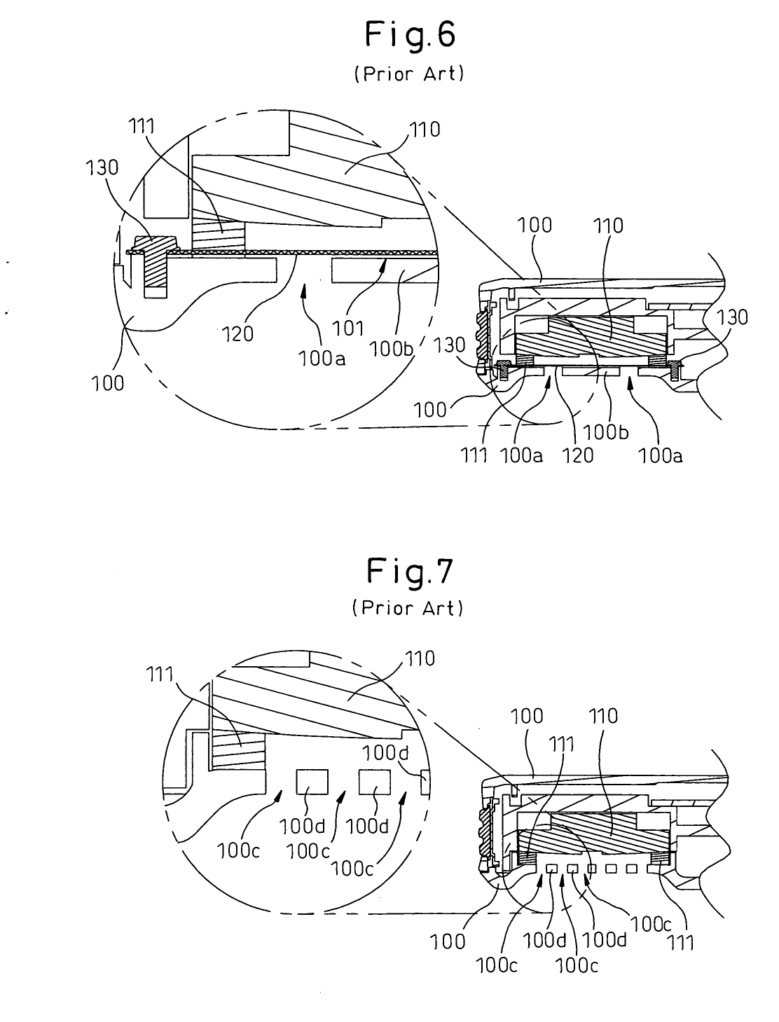

Furthermore, in the loudspeaker mounting structure shown in FIG. 6, the loudspeaker mesh 120 that is included in the loudspeaker mounting structure shown in FIG. 2 is made of a metal or a resin for fear the loudspeaker mesh may resonate and interfere with the housing. The metallic or resin loudspeaker mesh 120 is attached to the housing 100 using screws 130.

The loudspeaker mounting structure shown in FIG. 7 does not, unlike the loudspeaker mounting structure shown in FIG. 2, include the loudspeaker mesh 120. Instead, a spacing between adjoining ones of the sound release cavities formed in the housing 100 is reduced, that is, the width of the crosspieces 100d extending among the sound release cavities 100d is reduced. Otherwise, the sound release cavities 100c are formed like open spaces of a lattice so that the housing 100 itself will have the capability of the loudspeaker mesh 120.

As mentioned above, the loudspeaker mounting structure shown in FIG. 2 has a drawback that the loudspeaker mesh 120 resonates with sounds or voice radiated from the loudspeaker 110 to cause abnormal noise or that the resonant loudspeaker mesh 120 interferes with the housing 100 or the loudspeaker 110 to cause abnormal noise.

Moreover, in the loudspeaker mounting structures shown in FIGS. 3 and 4, a part or the whole of the loudspeaker mesh 120 is bonded to the housing 100 or the cover (loudspeaker 110) of the loudspeaker unit using the adhesive 102 or 103. Therefore, an additional part is needed and an assembling process becomes complex. This must increase the cost. Moreover, the same applies to a case where a double-sided adhesive tape is substituted for the adhesive 102 or 103.

Furthermore, in the loudspeaker mounting structure shown in FIG. 3, as the sound release cavities 100a are formed in the housing 100, there is difficulty in preserving a sufficient area for bonding. Moreover, if the adhesive 102 oozes out to the sound release cavities 100a, the appearance of the housing is impaired. This makes it necessary to perform design or assembly in consideration of a region or a range to which the loudspeaker mesh 120 is bonded. This poses a problem in that a large load is imposed on design or assembly. In the loudspeaker mounting structure shown in FIG. 4, the large space 104 is created between the housing 100 and the loudspeaker mesh 120, dust and dirt or a foreign matter is likely to remain therein.

In the loudspeaker mounting structure shown in FIG. 5, a sufficient distance is preserved between the loudspeaker mesh 120 and the housing 100 and between the loudspeaker mesh 120 and the loudspeaker 110. However, as the resonance of the loudspeaker mesh 120 is not prevented, abnormal noises derived from the resonance of the loudspeaker mesh 120 cannot be nullified. Furthermore, similarly to the loudspeaker mounting structure shown in FIG. 4, a relatively large space 105 is created between the housing 100 and the loudspeaker mesh 120. Therefore, dust and dirt or a foreign matter is likely to remain therein. Moreover, when the loudspeaker mesh 120 is made from fibers, after the loudspeaker mesh 120 is attached, the loudspeaker mesh may sag depending on temperature or humidity. Consequently, the distance from the loudspeaker mesh to the housing or loudspeaker may become insufficient during manufacture. This may bring about abnormal noise.

Moreover, in the loudspeaker mounting structure shown in FIG. 6, as the loudspeaker mesh 120 is made of a metal or a resin, the price of the loudspeaker mesh becomes higher than that of a loudspeaker mesh made from fibers. Moreover, screws are used to fix the loudspeaker mesh to the housing 100 or the loudspeaker 120. Mounting the loudspeaker thus becomes expensive.

Furthermore, the loudspeaker mounting structure shown in FIG. 7 does not employ a loudspeaker mesh that resonates. Instead, the spacing between adjoining ones of the sound release cavities 100c formed in the housing 100 is reduced, or the sound release cavities 100c are formed like open spaces of a lattice. From the viewpoint of manufacturing technologies, it is hard to form holes as finely as the open spaces of a loudspeaker mesh in the housing. Moreover, the loudspeaker 110 may be seen as it is through the sound release cavities 100c from outside the housing 100, and a dustproof and waterproof feature cannot be fully ensured.

An embodiment of a sounding body unit in accordance with the present invention will be described with reference to the appended drawings below.

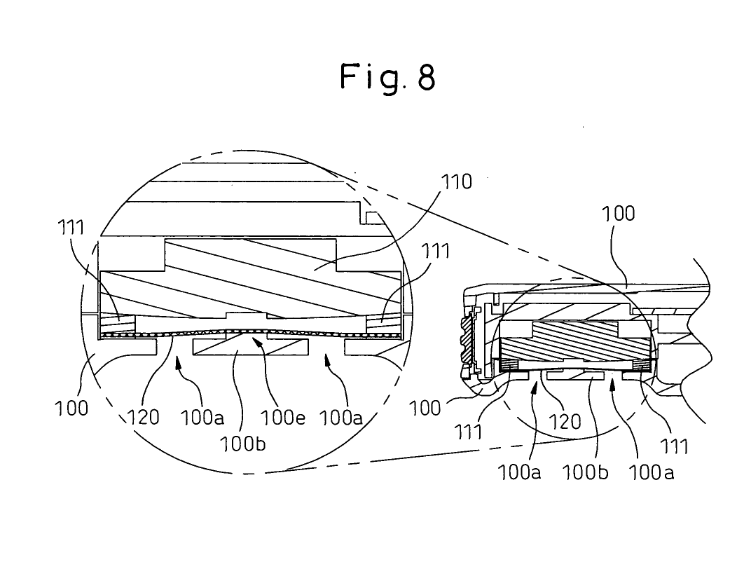

FIG. 8 shows an embodiment of a sounding body unit (loudspeaker mounting structure) in accordance with the present invention.

As is apparent from a comparison of FIG. 8 with FIG. 2, the sounding body unit of the present embodiment has a projection 100e formed as an integral part of a crosspiece 100b extending between sound release cavities 100a formed in a housing 100. The projection 100e is pressed against a loudspeaker mesh 120 in order to prevent the loudspeaker mesh 120 from resonating with sounds radiated from a loudspeaker 110. Thus, as the projection 100e is formed on the crosspiece 100b extending between the sound release cavities 100a, the strength of the crosspiece 100b is improved because of the increased thickness thereof.

As mentioned above, as the projection 100e presses the loudspeaker mesh 120, the loudspeaker mesh 120 is tensioned to such an extent that it cannot resonate. Thus, the resonance of the loudspeaker mesh with sounds radiated from the loudspeaker 110 is prevented, and the sounds radiated from the loudspeaker 110 can be clearly released to the outside of the housing 100.

The projection 100e is formed on one crosspiece 100b or a plurality of crosspieces 100b extending between or among the sound release cavities 100a formed in the housing 100. Moreover, as described later, any of projections of various shapes or any number of projections may be formed at any of various places.

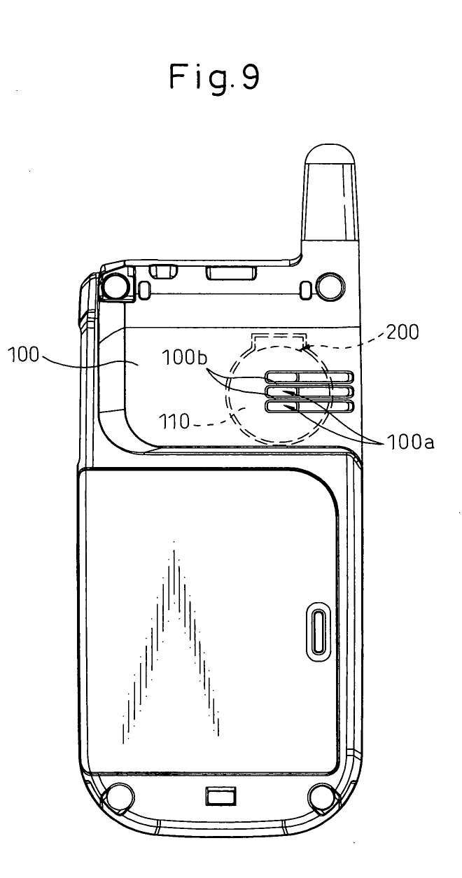

FIG. 9 shows the back of a mobile cellular phone that is an example to which the sounding body unit in accordance with the present invention is adapted.

As shown in FIG. 9, for example, the sound release cavities 100a are formed in a place corresponding to the center of the loudspeaker 110 included in the loudspeaker unit (sounding body unit) 200. Sounds radiated from the loudspeaker 110 are effectively released to the outside of the housing 100.

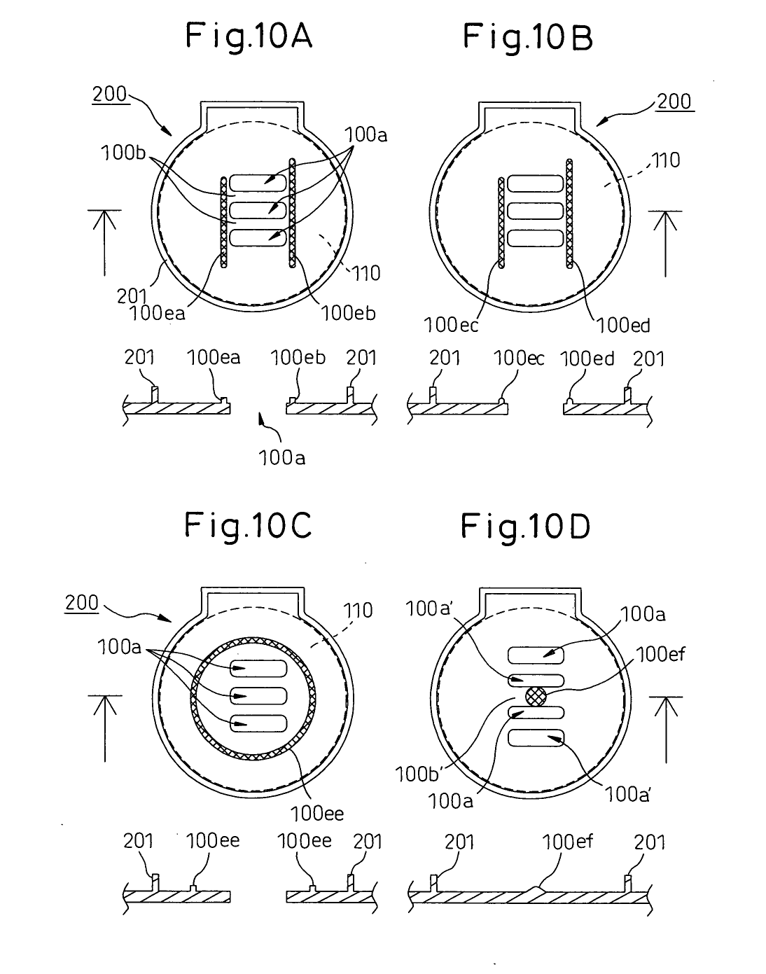

FIGS. 10A to 10D show examples of the shape of a projection included in the sounding body unit in accordance with the present invention, and show projections of different shapes formed in different places. In FIGS. 10A to 10D, reference numeral 201 denotes a loudspeaker positioning projection used to position and mount the loudspeaker 110.

The sounding body units shown in FIGS. 10A and 10B have two projections 100ea and 100eb or two projections 100ec and 100ed, which have a linear planar shape, formed on both sides of three sound release cavities 100a formed in the housing (100). Referring to FIGS. 10A and 10B, the left-hand projections 100ea and 100ec are shorter upwards than the right-hand projections 100eb and 100ed are. The shape of the projections is varied depending on the shape of the loudspeaker 110, loudspeaker mesh 120, sound release cavities 100a, or any other part or the shape of the housing 100.

The projections 100ea and 100eb shown in FIG. 10A have a rectangular section as apparent from the sectional views. In contrast, the projections 100ec and 100ed shown in FIG. 10B have a rectangular section whose end that comes into contact with the loudspeaker mesh is rounded (upper end in the drawing). The width of the section of each of the projections is set to a value permitting the projection to apply an appropriate tensile force to the loudspeaker mesh so as to prevent the loudspeaker mesh from resonating. Herein, the value is determined with the material and thickness of the loudspeaker mesh, a material made into the projection, or an area by which the projection is in contact with the loudspeaker mesh.

The sounding body unit shown in FIG. 10C has a projection 100ee, which has a circular planar shape, formed around the three sound releasing cavities 100a formed in the housing 100. The circular projection 100ee may not have, similarly to the foregoing linear projection, a perfectly rectangular section but may have a section whose end that comes into contact with the loudspeaker mesh is rounded. The size of the circular projection 100ee and the width of the section of the projection are determined appropriately according to other various factors.

The sounding body unit shown in FIG. 10D has four sound release cavities 100a and 100a′ formed in the housing 100. Two inner sound release cavities 100a′ are made slightly smaller, and a crosspiece 100b′ extending between the inner sound release cavities is made wider. A projection 100ef that is a conical projection having a circle-like planar shape and a triangular section is formed on the center crosspiece 100b′. The loudspeaker mesh 120 has the center part thereof alone pressed by the projection 100ef. Needless to say, the height of the conical projection 100ef is determined with the material and thickness of the loudspeaker mesh, the spacing between the loudspeaker and the loudspeaker mesh, or any other factor.

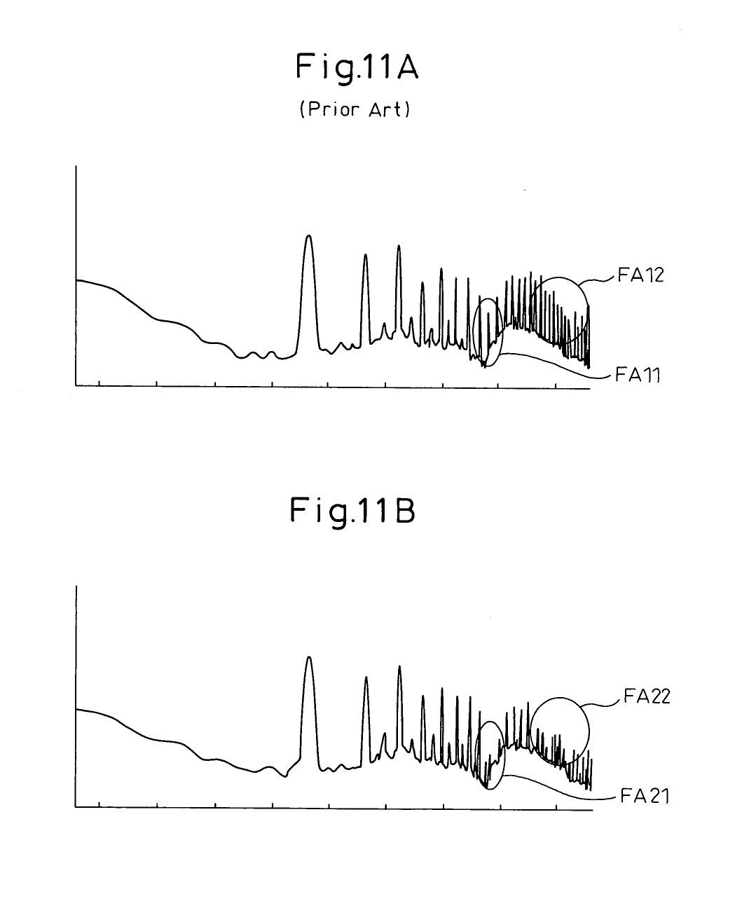

FIGS. 11A and 11B show examples of waveforms measured using the loudspeaker mounting structures in accordance with the prior art and the present invention respectively. FIG. 11A shows the waveform measured using the loudspeaker mounting structure in accordance with the prior art shown in FIG. 2, and FIG. 11B shows the waveform measured using the loudspeaker mounting structure in accordance with the present invention.

When the present invention is applied, for example, abnormal noises (see FA11 and FA12 in FIG. 11A) falling within a predetermined range of frequencies are largely reduced as indicated with FA21 and FA22 in FIG. 11B.

As mentioned above, in the embodiments of a sounding body unit in accordance with the present invention, for example, resonance of a loudspeaker mesh with sounds or voice radiated from a loudspeaker is prevented. Consequently, occurrence of unpleasant noise derived from the resonance of the loudspeaker mesh or interference with a housing caused by the resonance is prevented. Eventually, the quality or clarity of sounds or voice radiated from the loudspeaker and released through sound release cavities will not be adversely affected.

Moreover, in the embodiments of the present invention, a projection is formed as an integral part of a housing. This obviates the necessity of a part dedicated to bonding or fixing and prevents an increase in a cost. Furthermore, the height, position, and shape of the projection can be readily adjusted irrespective of the technologically feasible dimensions of the part dedicated to bonding or fixing.

In the embodiments of the present invention, when a housing is molded using a resin, the fluidity of the resin is degraded because of the presence of sound release cavities. Therefore, a weld or the like is created to deteriorate the mechanical strength of a portion of the housing around the sound release cavities. However, when a projection is formed on, for example, a crosspiece between sound release cavities, the resonance of a mesh section can be prevented and the strength of the portion of the housing in which the sound release cavities are formed can be increased. Moreover, as the thickness of the margins of the sound release cavities can be increased, the fluidity of a resin observed during molding is estimated to improve and occurrence of a weld or the like is expected to decrease.

As mentioned above, according to the present invention, there is provided a sounding body unit that can nullify the resonance of a mesh section with sounds radiated from a sounding body, and can prevent occurrence of abnormal noise due to the resonance of the mesh section or interference with a housing derived from the resonance.

The present invention can be widely applied to various pieces of equipment, which have a structure by which a sounding body is mounted on a housing with a mesh section between them, including a mobile cellular phone that has a loudspeaker unit provided with a dustproof net. For example, the present invention can be applied to a compact communications terminal, a telephone set, portable music reproduction equipment, and a compact radio. The sounding body is not limited to a loudspeaker but may include, for example, a buzzer required for realizing an alarm facility.

Many different embodiments of the present invention may be constructed without departing from the scope of the present invention, and it should be understood that the present invention is not limited to the specific embodiments described in this specification, except as defined in the appended claims.

What is claimed is:

1. A sounding body unit comprising a sounding body, a mesh section, and a housing mounting said sounding body with said mesh section, wherein:
said housing has a projection; and
said projection is pressed against said mesh section in order to prevent said mesh section from resonating with sounds radiated from said sounding body.

2. The sounding body unit as claimed in claim 1, wherein:
said sounding body is a loudspeaker that radiates sounds or voice to the outside from said housing;
said mesh section is a net interposed between sound release cavities formed in said housing and said loudspeaker, preventing invasion of dust and dirt, preventing permeation of dripping water, and improving an appearance of said housing.

3. The sounding body unit as claimed in claim 2, wherein said projection is formed around said sound release cavities formed in said housing, and has a linear planar shape, a curved planar shape, or a combination of the shapes.

4. The sounding body unit as claimed in claim 3, wherein said projection has a rectangular section or a rectangular section whose end that comes into contact with said mesh section is rounded.

5. The sounding body unit as claimed in claim 2, wherein said projection is formed on a crosspiece between said sound release cavities formed in said housing.

6. The sounding body unit as claimed in claim 1, wherein said projection is formed as an integral part of the housing.

7. The sounding body unit as claimed in claim 5, wherein said projection is formed on a center crosspiece between said sound release cavities formed in said housing, and realized with a substantially conical projection having a circle-like planar shape and a triangular section.

8. A device having a sounding body unit, said sounding body unit comprising a sounding body, a mesh section, and a housing mounting said sounding body with said mesh section, wherein:
said housing has a projection; and
said projection is pressed against said mesh section in order to prevent said mesh section from resonating with sounds radiated from said sounding body.

9. The device as claimed in claim 8, wherein:
said sounding body is a loudspeaker that radiates sounds or voice to the outside from said housing;
said mesh section is a net interposed between sound release cavities formed in said housing and said loudspeaker, preventing invasion of dust and dirt, preventing permeation of dripping water, and improving an appearance of said housing.

10. The device as claimed in claim 9, wherein said projection is formed around said sound release cavities formed in said housing, and has a linear planar shape, a curved planar shape, or a combination of the shapes.

11. The device as claimed in claim 10, wherein said projection has a rectangular section or a rectangular section whose end that comes into contact with said mesh section is rounded.

12. The device as claimed in claim 9, wherein said projection is formed on a crosspiece between said sound release cavities formed in said housing.

13. The device as claimed in claim 8, wherein said projection is formed as an integral part of the housing.

14. The device as claimed in claim 12, wherein said projection is formed on a center crosspiece between said sound release cavities formed in said housing, and realized with a substantially conical projection having a circle-like planar shape and a triangular section.
